(19) United States
(12) Patent Application Publication
(10) Pub. No.: US 2011/0148687 A1
(43) Pub. Date: Jun. 23, 2011

(54) ADJUSTABLE ANTENNA

(75) Inventors: Donald Wright, Orlando, FL (US); Jeffery Carter May, Melbourne, FL (US)

(73) Assignee: L-3 COMMUNICATIONS CYTERRA CORPORATION, Orlando, FL (US)

(21) Appl. No.: 12/971,343

(22) Filed: Dec. 17, 2010

Related U.S. Application Data
(60) Provisional application No. 61/287,999, filed on Dec. 18, 2009.

(51) Int. Cl. G01S 13/00; H01Q 1/24; H01Q 3/01; G01S 13/08; G01S 13/04

(52) U.S. Cl. 342/22; 343/757; 343/702; 343/758; 342/118; 342/27

(57) ABSTRACT

A device includes a compressible conductive element including a first end and a second end, and an adjustment element coupled to the compressible conductive element, the adjustment element configured to adjust the compressible conductive element to a state of compression between an uncompressed mode and a compressed mode. The compressible conductive element is configured to couple to a source of electrical current at the first end and to radiate electromagnetic energy from the second end.

### CROSS-REFERENCE TO RELATED APPLICATION

This application claims the benefit of U.S. Provisional Application Ser. No. 61/287,999, titled MOTION DETECTION WITH AN ADJUSTABLE CONICAL SPIRAL ANTENNA, and filed on Dec. 18, 2009, which is incorporated by reference in its entirety.

### TECHNICAL FIELD

This description relates to an adjustable antenna.

### BACKGROUND

Detection sensors may be used to determine the presence of objects when visual recognition is difficult.

### SUMMARY

In one general aspect, a device includes a compressible conductive element including a first end and a second end, and an adjustment element coupled to the compressible conductive element, the adjustment element configured to adjust the compressible conductive element to a state of compression between an uncompressed mode and a compressed mode. The compressible conductive element is configured to couple to a source of electrical current at the first end and to radiate electromagnetic energy from the second end.

Implementations may include one or more of the following features. The electromagnetic energy radiated from the second end of the compressible conductive element may be a beam of electromagnetic energy, and a beamwidth of the beam may be narrower in the uncompressed mode than in the compressed mode. The adjustment element may be configured to allow the compressible conductive element to adjust to any state between the uncompressed mode and the compressed mode, including the uncompressed mode or the uncompressed mode. The adjustment element may be at least partially surrounded by the conductive element. The conductive element may include a spring, and the adjustment element may be positioned substantially along a longitudinal axis of the spring and coupled to a portion of one or more of the first end or the second end. The adjustment element may adjust the conductive element by contacting the first end of the conductive element or the second end of the conductive element, and the adjustment element may be at least partially external to the conductive element.

The compressible conductive element may include two conductive elements, a first conductive element and a second conductive element, and current from the source of electric current may flow into a first conductor electrically connected to the first conductive element and into a second conductor electrically connected to the second conductive element. Each of the first conductive element and the second conductive elements may include a spring, and the first conductive element and the second conductive element may be wound in proximity to each other. A motor may be coupled to the adjustment element, and the adjustment element may adjust the compressible conductive element with the motor. The adjustment element may be nonconductive.

In another general aspect, an adjustable conical spiral antenna includes a conductive element that receives a current and produces a beam of electromagnetic radiation. The conductive element is adjustable from a compressed mode associated with a beam that radiates in substantially all directions to an uncompressed mode associated with a beam that produces a directional beam that radiates preferentially in a particular direction.

Implementations may include one or more of the following features. The adjustment element may be configured to cause the conductive element to compress and expand.

In another general aspect, a method includes positioning a conductive element of an adjustable spiral antenna in a first mode such that the spiral antenna produces a first radiation pattern, and positioning the conductive element of the adjustable spiral antenna in a second mode such that the spiral antenna produces a second radiation pattern. The first mode corresponds to a different compression state than a compression state corresponding to the second mode and the first radiation pattern is different from the second radiation pattern.

Implementations may include one or more of the following features. The first mode may be a compressed mode, and the first radiation pattern includes electromagnetic energy emitted from an end of the antenna in substantially all directions, and the second mode may be an uncompressed mode, and the second radiation pattern may include electromagnetic energy emitted from an end of the antenna in substantially one direction.

The first radiation pattern may be directed at an object in proximity to the end of the antenna, and the second radiation pattern may be directed at an object at a distance from the end of the antenna.

It may be determined that an object is in proximity to the end of the antenna, and the first radiation pattern may be directed towards the object after the determination. It may be determined that an object is at a distance from the end of the is antenna, and the second radiation pattern may be directed towards the object after the determination. The object may be a base station that forms part of a wireless link, and the second radiation pattern includes information set to or received from the base station. The object may be a person. The object may be a barrier that forms a portion of a building, and the first radiation pattern penetrates the building.

In another general aspect, a system includes one or more adjustable antennas, each adjustable antenna including a first end and a second end, the first end being electrically coupleable to a source of electrical current, and each antenna configured to produce and receive electromagnetic radiation at the second end; an adjustment element coupleable to the one or more adjustable antennas; and a processor coupled to the one or more adjustable antennas.

Implementations may include one or more of the following features. The processor may be configured to receive a signal based on the received electromagnetic radiation and to analyze the signal. The system may include a housing that partially encloses the adjustable antennas, and the first end of the antennas may be coupled to a base of the housing. The adjustable element may include a lid that attaches to the housing and contacts the second end of the adjustable antennas to compress the adjustable antennas.

In another general aspect, a method includes transmitting a stepped-frequency radar signal from a first side of a wall to a second side of the wall; detecting reflections of the transmitted signal with a spiral antenna in an uncompressed position; generating data including information associated with frequency and phase shifts between the transmitted signal and the reflections of the transmitted signal detected with the spiral antenna in the uncompressed position; analyzing the data generated from reflections of the transmitted signal detected with the spiral antenna in the uncompressed position to determine information associated with a moving object located beyond the second side of the wall; detecting reflections of the transmitted signal with the spiral antenna in a compressed position; generating data including information associated with frequency and phase shifts between the transmitted signal and the reflections of the transmitted signal detected with the spiral antenna in the compressed position; and analyzing the data generated from reflections of the transmitted signal detected with the spiral antenna in the compressed position to determine information associated with a moving object located beyond the second side of the wall.

In another general aspect, a device including a spiral antenna is configured to transmit a stepped-frequency radar signal from a first side of a wall to a second side of the wall, detect reflections of the transmitted signal with a spiral antenna in an uncompressed position, generate data including information associated with frequency and phase shifts between the transmitted signal and the reflections of the transmitted signal detected with the spiral antenna in the uncompressed position, analyze the data generated from reflections of the transmitted signal detected with the spiral antenna in the uncompressed position to determine information associated with a moving object located beyond the second side of the wall, detect reflections of the transmitted signal with the spiral antenna in a compressed position, generate data including information associated with frequency and phase shifts between the transmitted signal and the reflections of the transmitted signal detected with the spiral antenna in the compressed position, and analyze the data generated from reflections of the transmitted signal detected with the spiral antenna in the compressed position to determine information associated with a moving object located beyond the second side of the wall.

Implementations of the techniques discussed above may include a method or process, a system or apparatus, or computer software on a computer-accessible medium.

### DESCRIPTION OF DRAWINGS

FIG. 1A is a diagram illustrating an example of adjustability of a conical spiral antenna.

FIG. 1B is a diagram illustrating an example of an adjustable spiral antenna in an uncompressed mode.

FIG. 1C is a diagram illustrating an example of the adjustable spiral antenna in a compressed mode.

FIG. 1D is a diagram of a system that includes an adjustable spiral antenna.

FIG. 2 is a diagram illustrating an example of operation of conical spiral antennas in a compressed mode.

FIG. 3 is a diagram illustrating an example of operation of conical spiral antennas in an uncompressed mode.

FIG. 4 is a flow chart illustrating an example of a process for detecting moving objects with an adjustable conical spiral antenna.

FIG. 5 is a flow chart illustrating an example of a process for using an adjustable antenna.

Like reference symbols in the various drawings indicate like elements.

### DETAILED DESCRIPTION

An adjustable antenna is disclosed. The adjustable antenna includes a conductive element that is electrically connected to a source of electrical current at a first end, and the conductive element transmits and receives electromagnetic radiation at a second end. The pattern of electromagnetic radiation emitted from the second end of the conductive element is determined by the length of the conductive element as compared to the diameter of the conductive element. The length of the conductive element is variable, resulting in an antenna that is adjustable to the needs of the user by producing a variable beamwidth beam of electromagnetic radiation.

The conductive element of the adjustable antenna is adjustable from a compressed mode having a relatively short length to an uncompressed mode having a relatively long length. In the compressed mode, the second end of the antenna radiates in substantially all directions to produce a radiation pattern that is isotropic, or nearly isotropic, and, thus, produces a beam that has wide beamwidth. In the uncompressed mode, the second end of the antenna radiates preferentially in a particular direction, producing a beam with a narrow beamwidth. The radiation to patterns of compressions between a fully compressed state and an uncompressed or expanded state vary from the isotropic pattern to a highly directional beam.

Thus, the adjustable antenna is a device that produces a beam that is customizable based on the amount of compression of the conductive element. This is in contrast to some prior systems that include a conductive element having a fixed geometry that produces a radiation pattern determined by the fixed geometry of the conductive element. To produce a radiation pattern other than the predetermined radiation pattern using such a system, multiple antennas may be arranged relative to one another in an array such that the radiation produced by each of the multiple antennas constructively and/or destructively interferes to produce an aggregate radiation pattern that is different than the radiation pattern produced by a single antenna. However, the adjustable antenna discussed below may achieve a variable radiation pattern in a single device that includes an adjustable conductive element.

The adjustable antenna may be employed in any scenario in which having a variable beamwidth may improve system performance. For example, the adjustable antenna may be used in a hand-held device that monitors a scene that includes a building in which a person is present and another person is positioned at a distance away from the building. The adjustable antenna may be placed in front of the building, and the antenna compressed to produce a wide beam that examines around and through a wall of the building to detect the presence of people inside the building. Additionally, the operator of the antenna may turn the antenna towards the person at a distance from the building, and, using the antenna in the uncompressed mode, direct a narrow beam towards the distant person to monitor the person. Accordingly, the adjustable antenna allows such a device to be used in a scenario with targets at different ranges and/or allows a single device to be used in multiple scenarios that present various observation challenges.

Additionally, use of the narrow beam to monitor the distant person results in a higher portion of energy produced by the antenna striking the person rather than clutter (such as trees and shrubs) positioned to the side of a direct line-of-sight to the distant person. Thus, the availability of the narrow beam may result in data with less clutter because the trees and shrubs are not detected by the antenna, or the presence of the trees and shrubs in the data is diminished due to only a small amount of energy striking the clutter objects.

In another example, the adjustable antenna may be used as part of a wireless link system. In this example, in an area populated with many transceivers, the adjustable antenna may be uncompressed to produce a narrow beam that is directed towards a remote base station and avoids the local transceivers. In a remote area with few transceivers, a wide beam may be used to communicate with another link in the wireless link system.

In another example, the adjustable antenna may be part of a system that detects moving entities, such as walking or running persons or stationary, breathing persons. To detect the presence of entities through movement when visual detection is blocked (e.g., by a wall) or inadequate (e.g., at a distance), a device, such as a handheld scanner using stepped-frequency radar transmitter, may be employed. The device emits a radar based signal that includes different frequencies. The emitted signal strikes objects and is partially reflected. The reflected signal may be affected by environmental characteristics. For example, if an object is moving closer to or further from the device, signals reflected from the object will exhibit a frequency shift (i.e., a Doppler shift) that may be observed and processed by the device. Also, the distance a signal travels before or after being partially reflected affects the phase of the reflected signal at the receiver. Further, the location at which a signal is reflected affects the determination of an azimuth and elevation angle of the reflected signal.

The device may be used to aid in military or search and rescue missions. For example, soldiers may use the device to detect the presence of unknown individuals that may be hiding behind walls. A soldier may activate the device while aiming the transmitter such that the signal is pointed at a building wall or closed door. The signal may penetrate walls and doors, and partially reflect when striking an individual. The reflected portion of the signal may exhibit a frequency shift detectable by the device at one or more receiving antennas. The device receives and processes the reflected signal from the receiving antennas, and may determine a presence in three spatial dimensions of one or more entities. Also, the device may be used to detect the presence of individuals buried in piles of rubble based on subtle movement, such as breathing.

The device may include an adjustable conical spiral antenna used to transmit and/or receive signals (i.e., as a transmitter, receiver, or transceiver). The antenna may be manufactured from a spring or wire, for example. The thickness and temper is of the wire may be used to help make the antenna self-supporting, which may reduce or eliminate the need for backing material. To enable flexibility, for example, a metal wire may be used to form an antenna rather than using copper on a polyethylene terephthalate (e.g., Mylar™) backing. The adjustability of a conical spiral antenna may allow for the use of two or more modes during transmission and/or receipt of signals. The modes may include a “compressed” mode and an “uncompressed” mode. Only two modes are described below for convenience. Other modes, for example, with varying levels of compression may also be used.

A compressed mode generally enables the antenna to take up less space and may provide a greater beamwidth of a received signal, as compared with a compressed mode for the antenna. The beamwidth is generally considered the angle within which the antenna may send or receive signals with a signal strength of at least half (or −3 decibels) of the maximum sent or received signal strength. Also, the beamwidth may be measured along the azimuth or elevation angle from the antenna. The beamwidth represents the angular-span in which the device is able to send and/or receive signals effectively. For example, a device with a beamwidth of 45 degrees (with respect to the front of the device) may send and/or receive signals to and from objects within a 45 degrees span in front of the device while signals sent to and from objects outside of the span may be too weak to be effective in detecting objects. As such, when the device is particularly close to a room or area to be scanned, a wide beamwidth may be required to cover the entire area with a single scan.

The uncompressed mode allows for the antenna to enhance the signal gain. The signal gain may be proportional to the vertical length of the cone of the conical spiral antenna. Therefore, uncompressing the antenna increases the vertical length and the signal gain of the antenna. A high signal gain may be useful for detecting reflections of small magnitude or with subtle frequency shifts. When the device is particularly far from a room or area to be scanned, a high signal gain may be helpful in detecting all relevant objects.

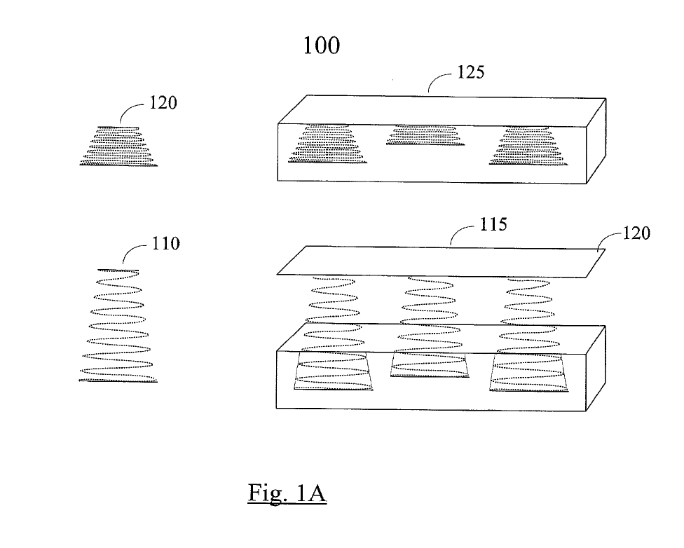

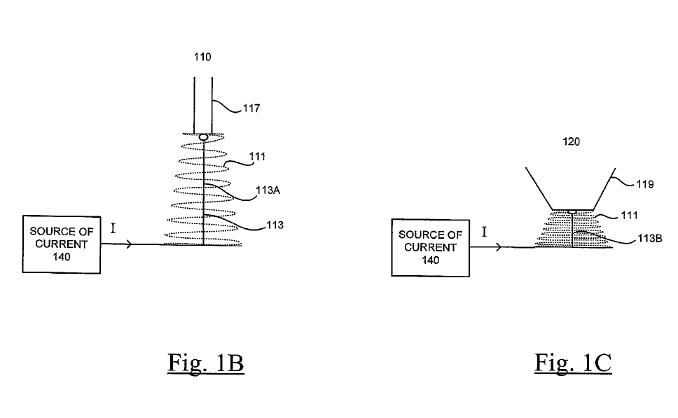

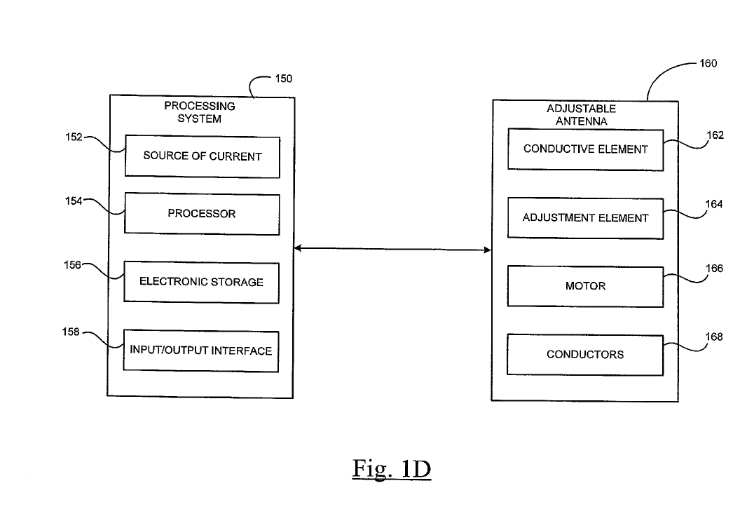

FIG. 1A is a diagram 100 illustrating an example of adjustability of a conical spiral antenna. The diagram 100 includes an uncompressed antenna 110, a device with uncompressed antennas 115, a compressed antenna 120, and a device with is compressed antennas 125. The device with uncompressed antennas 115 and the device with compressed antennas 125 may represent two different modes of the same device.

The uncompressed antenna 110 represents a conical spiral antenna with a greater vertical length (i.e., length from the base of the cone to the top of the cone). The uncompressed state of the uncompressed antenna 110 may represent the natural physical state of the antenna when not forced into a particular shape. The uncompressed antenna 110 exhibits a greater signal gain due to its greater vertical length. The device with uncompressed antennas 115 includes three uncompressed antennas in differing positions. The use of three uncompressed antennas may allow for determination of azimuth and elevation angle of detected signals through triangulation.

The compressed antenna 120 represents a conical spiral antenna with a shorter vertical length. The compressed state of the compressed antenna 120 may represent the physical state of the antenna when both ends of the cone are forced towards each other or when one end of the cone is forced towards the other end. The compressed antenna 120 exhibits a greater signal gain due to its shorter vertical length. The device with uncompressed antennas 125 includes three compressed antennas in differing positions. The use of three compressed antennas may allow for determination of azimuth and elevation angle of detected signals through triangulation.

A single device including conical spiral antennas may be configured to enable the antennas to be adjusted to either compressed or uncompressed states. For example, a user may press a switch, flip a latch, or otherwise interact with the device to release the conical spiral antennas from their compressed state. When released, the antennas may expand into the uncompressed state. Thereafter, the device may again be placed into the compressed state through further user interaction. As shown, the device with uncompressed antennas 125 includes a top covering 120 that rises with the uncompressed antennas. The covering allows for ease of user recompression of the antennas. Other devices, however, may be configured differently and may not include a covering. The devices may be referred to as an adjustment element. In this manner, the conical spiral antennas of a device may be used both in an uncompressed state for a greater signal gain and in a compressed state for a greater beamwidth.

FIG. 1B is a diagram of the uncompressed antenna 110, and FIG. 1C is a diagram of the compressed antenna 120. The uncompressed antenna 110 shown in FIG. 1B produces a beam 117 that has a narrow beamwidth, and the compressed antenna 120 shown in FIG. 1C produces a beam 119 that has a wide beamwidth. The conductive element 111 is electrically connected to a source of current 140 that provides current to the conductive element 111.

An example adjustment element 113 is shown in an extended state 113A (FIG. 1B) and in a retracted state 113B (FIG. 1C). The adjustment element 113 is surrounded by a conductive element 111 of the antenna. In the example shown, the adjustment element 113 is positioned along a central longitudinal axis of the conductive element 111. The adjustment element 113 retracts or compresses into a retracted state 113A to compress the conductive element 111. In some implementations, the adjustment element 113 may be coupled to a motor or other mechanism that aids in compressing the adjustment element 113. The adjustment element 113 may include bellows or other adjustable components. The adjustment element 113 may attach to either or both ends of the conductive element 111. The adjustment element 113 includes nonconductive material such that the adjustment element 113 does not affect the radiation pattern produced by the conductive element 111.

FIG. 1D shows a block diagram of a system that includes a processing system 150 and an adjustable antenna 160. The processing system 150 includes a source of current 152, a processor 154, an electronic storage 156, and an input/output interface 158. The adjustable antenna 160 includes a conductive element 162, an adjustment element 164, and conductors 168 to couple the conductive element 162 to the source of current 152 and the processing system 150. The adjustable antenna 160 may include a motor 166 or other mechanism to compress or expand the adjustment element 164.

The conductive element 162 may be made from any electrically conductive, resilient material. For example, the conductive element 162 may include beryllium copper or stainless steel. The conductive element 162 is compressible between a fully compressed mode and an extended mode and may assume any compressed state between, and including, the fully compressed mode and the extended mode. The adjustment element 164 acts to transition the conductive element 162 among modes. The conductive element 162 may be a spring-like element, and the conductive element 162 may include multiple springs, each of which may be connected to an individual conductor 168.

The processing system 150 includes an electronic storage 156, which stores instructions and/or a computer program that, when executed, cause the processor 154 to perform actions. For example, the processor 154 may receive signals from the conductive element 162 and analyze the signals to determine that an object in close proximity to the conductive element 162. The input/output interface 158 may present data analyzed by the processor 154 visually on a display and/or audibly. The input/output interface 158 may accept commands from an input device to configure the adjustable antenna 160 or update data stored in the electronic storage 156.

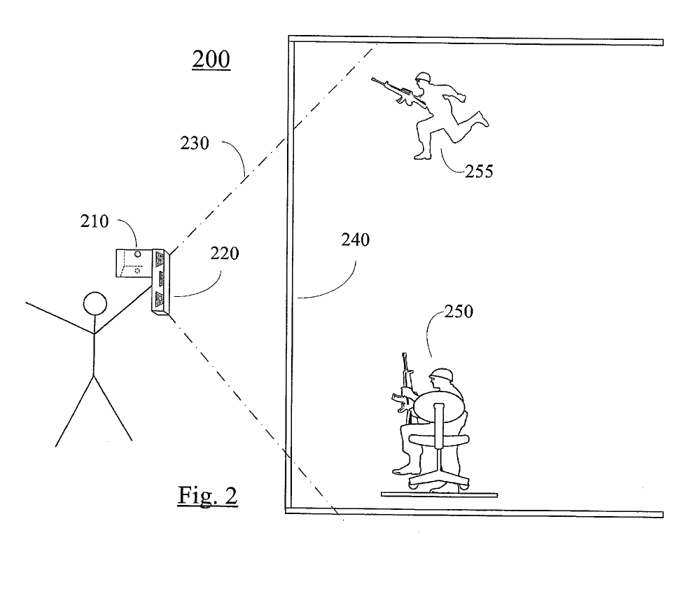

FIG. 2 is a diagram 200 illustrating an example of operation of conical spiral antennas in a compressed mode 220. In the diagram 200, a user is operating a device 210 with conical spiral antennas in a compressed mode 220 to scan for moving entities 250 and 255 in an adjacent room 240. The compressed mode represents a mode particularly useful to the situation illustrated by the diagram 200. In particular, because the user is next to the room 240, a wide beamwidth is required for the device to be able to detect both of the moving entities 250 and 255 with a single scan. In this example, the device exhibits a beamwidth 230 of greater than 90 degrees in its uncompressed state. The signal gain of the antenna may be, for example, less than 10 dB. Because the moving entities 250 and 255 are nearby, a larger signal gain is not required for detection.

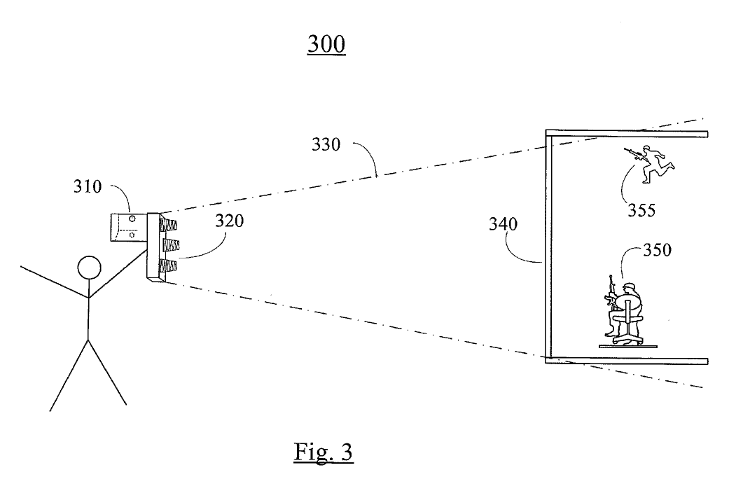

FIG. 3 is a diagram 300 illustrating an example of operation of conical spiral antennas in an uncompressed mode 320. In the diagram 300, a user is operating a device 310 with conical spiral antennas in an uncompressed mode 320 to scan for moving entities 350 and 355 in a room at a distance 340. The uncompressed mode represents a mode particularly useful to the situation illustrated by the diagram 300. In particular, because the user is at a distance from the room 340, a large signal gain may be required to be able to detect both the entity moving insignificantly 350 and the entity with pronounced movement 355. In this example, the signal gain of the uncompressed antennas is greater than 10 dB. Also, the beamwidth 330 of the uncompressed antennas is less than 90 degrees. However, because the room is at a distance, a beamwidth of less than 90 degrees is more than adequate to fully scan the span of the room.

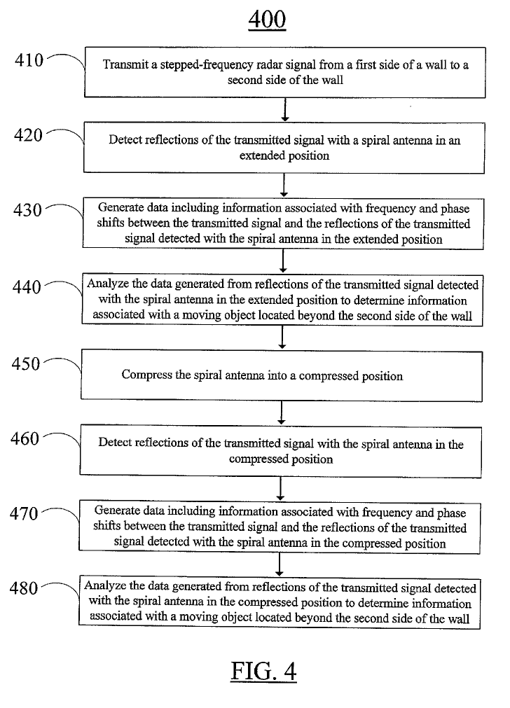

FIG. 4 is a flow chart illustrating an example of a process 400 for detecting moving objects with an adjustable conical spiral antenna. The process 400 may be carried out on the antenna(s) and/or device(s) shown in FIG. 1 or used in FIGS. 2 and 3 as discussed above. The process begins by transmitting a stepped-frequency radar signal from a first side of a wall to a second side of the wall (410). A spiral antenna in an uncompressed state detects reflections of the transmitted signal (420). The uncompressed state also may be referred to as an uncompressed position or an uncompressed mode. Data including information associated with frequency and phase shifts between the transmitted signal and the reflections of the transmitted signal detected with the spiral antenna in the uncompressed state is generated (430). The data generated from reflections of the transmitted signal detected with the spiral antenna in the uncompressed state is analyzed to determine information associated with a moving object located beyond the second side of the wall (440).

Thereafter, the spiral antenna is compressed into a compressed state (450). The compressed state also may be referred to as a compressed position or mode. The spiral antenna in the compressed state detects reflections of the transmitted signal (460). Data including information associated with frequency and phase shifts between the transmitted signal and the reflections of the transmitted signal detected with the spiral antenna in the compressed state is generated (470). The data generated from reflections of the transmitted signal detected with the spiral antenna in the compressed state is analyzed to determine information associated with a moving object located beyond the second side of the wall (480).

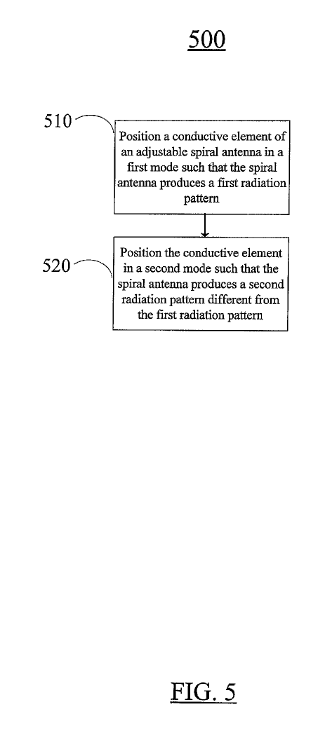

FIG. 5 illustrates a flow chart of an example process 500. A conductive element of a spiral antenna (such as the conductive element 113) is positioned in a first mode such that the spiral antenna produces a first radiation pattern (510). The conductive element is positioned in a second mode such that the spiral antenna produces a second radiation pattern (520). The second radiation pattern is different from the first radiation pattern. The first mode corresponds to a different compression state than a compression state corresponding to the first mode. For example, the first mode may be a compressed mode (such as the compressed mode 120 shown in FIG. 1A), and the second mode may be an uncompressed mode in which the conductive element is allowed to expand to its relaxed position (such as the uncompressed mode 110 shown in FIG. 1A). The second mode may be an extended mode in which the conductive element is stretched to lengthen beyond its relaxed position. Thus, to position the conductive element into the first mode, the conductive element may be compressed. To position the conductive element into the second mode, the conductive element may be allowed to expand from the compressed state. For example, the conductive element may be allowed to expand to the relaxed state, expand to a point of less than full compression, and/or expanded beyond the length corresponding with the relaxed state.

In this example, the antenna produces a wide beamwidth beam in the first mode and a narrow beamwidth beam in the second mode. The wide beamwidth beam may be a beam that radiates from the conductive element 113 substantially equally in all directions and the narrow beamwidth beam may be a beam that radiates from the conductive element 113 in a particular direction.

In some implementations, the first radiation pattern may be directed towards an object that is in proximity to the end of the antenna, and the second radiation pattern may be directed towards an object that is at a distance from the end of the antenna. For example, the first radiation pattern may be directed towards a wall that is directly in front of or touching the antenna or a component coupled to the antenna (such as the top cover 120). The second radiation pattern may be directed towards an object at a distance from the end of the antenna, such as a person barely visible to a human operator of the antenna or a remote transceiver that is included in a wireless link system. The presence of an object in proximity to the end of the antenna or at a distance from the end of the antenna may be determined prior to directing the respective radiation pattern toward the object. For example, data from the antenna may be analyzed by the processor 154 to detect the presence of the object and to determine a range (distance) to the object from the antenna.

Other implementations are within the scope of the following claims.

What is claimed is:

1. A device comprising:
a compressible conductive element comprising a first end and a second end, the compressible conductive element configured to couple to a source of electrical current at the first end and to radiate electromagnetic energy from the second end; and
an adjustment element coupled to the compressible conductive element, the adjustment element configured to adjust the compressible conductive element to a state of compression between an uncompressed mode and a compressed mode.

2. The device of claim 1, wherein the electromagnetic energy radiated from the second end of the compressible conductive element is a beam of electromagnetic energy, and a beamwidth of the beam is narrower in the uncompressed mode than in the compressed mode.

3. The device of claim 1, wherein the adjustment element is configured to allow the compressible conductive element to adjust to any state between the uncompressed mode and the compressed mode, including the uncompressed mode or the uncompressed mode.

4. The device of claim 1, wherein the adjustment element is at least partially surrounded by the conductive element.

5. The device of claim 4, wherein the conductive element comprises a spring, and adjustment element is positioned substantially along a longitudinal axis of the spring and coupled to a portion of one or more of the first end or the second end.

6. The device of claim 1, wherein the adjustment element adjusts the conductive element by contacting the first end of the conductive element or the second end of the conductive element, and the adjustment element is at least partially external to the conductive element.

7. The device of claim 1, wherein the compressible conductive element comprises two conductive elements, a first conductive element and a second conductive element, and current from the source of electric current flows into a first conductor electrically connected to the first conductive element and into a second conductor electrically connected to the second conductive element.

8. The device of claim 7, wherein each of the first conductive element and the second conductive elements comprise a spring, and the first conductive element and the second conductive element are wound in proximity to each other.

9. The device of claim 1, further comprising a motor coupled to the adjustment element, and wherein the adjustment element adjusts the compressible conductive element with the motor.

10. The antenna of claim 1, wherein the adjustment element is nonconductive.

11. An adjustable conical spiral antenna, the antenna comprising a conductive element that receives a current and produces a beam of electromagnetic radiation, the conductive element being adjustable from a compressed mode associated with a beam that radiates in substantially all directions to an uncompressed mode associated with a beam that produces a directional beam that radiates preferentially in a particular direction.

12. The antenna of claim 11, further comprising an adjustment element configured to cause the conductive element to compress and expand.

13. A method comprising:
positioning a conductive element of an adjustable spiral antenna in a first mode such that the spiral antenna produces a first radiation pattern; and
positioning the conductive element of the adjustable spiral antenna in a second mode such that the spiral antenna produces a second radiation pattern, wherein the first mode corresponds to a different compression state than a compression state corresponding to the second mode and the first radiation pattern is different from the second radiation pattern.

14. The method of claim 13, wherein the first mode is a compressed mode, and the first radiation pattern comprises electromagnetic energy emitted from an end of the antenna in substantially all directions, and the second mode is an uncompressed mode, and the second radiation pattern comprises electromagnetic energy emitted from an end of the antenna in substantially one direction.

15. The method of claim 14, further comprising:
directing the first radiation pattern at an object in proximity to the end of the antenna; and
directing the second radiation pattern at an object at a distance from the end of the antenna.

16. The method of claim 14, further comprising:
determining that an object is in proximity to the end of the antenna; and
directing the first radiation pattern towards the object after the determination.

17. The method of claim 14, further comprising:
determining that an object is at a distance from the end of the antenna; and
directing the second radiation pattern towards the object after the determination.

18. The method of claim 17, wherein the object is a base station that forms part of a wireless link, and the second radiation pattern includes information set to or received from the base station.

19. The method of claim 17, wherein the object is a person.

20. The method of claim 16, wherein the object is a barrier that forms a portion of a building, and the first radiation pattern penetrates the building.

21. A system comprising:
one or more adjustable antennas, each adjustable antenna comprising a first end and a second end, the first end being electrically coupleable to a source of electrical current, and each antenna configured to produce and receive electromagnetic radiation at the second end;
an adjustment element coupleable to the one or more adjustable antennas; and
a processor coupled to the one or more adjustable antennas.

22. The system of claim 21, wherein the processor is configured to receive a signal based on the received electromagnetic radiation and to analyze the signal.

23. The system of claim 21, further comprising a housing that partially encloses the adjustable antennas, the first end of the antennas being coupled to a base of the housing.

24. The system of claim 23, wherein the adjustable element comprises a lid that attaches to the housing and contacts the second end of the adjustable antennas to compress the adjustable antennas.

25. A method comprising:
transmitting a stepped-frequency radar signal from a first side of a wall to a second side of the wall;
detecting reflections of the transmitted signal with a spiral antenna in an uncompressed position;
generating data including information associated with frequency and phase shifts between the transmitted signal and the reflections of the transmitted signal detected with the spiral antenna in the uncompressed position;
analyzing the data generated from reflections of the transmitted signal detected with the spiral antenna in the uncompressed position to determine information associated with a moving object located beyond the second side of the wall;
detecting reflections of the transmitted signal with the spiral antenna in a compressed position;
generating data including information associated with frequency and phase shifts between the transmitted signal and the reflections of the transmitted signal detected with the spiral antenna in the compressed position; and
analyzing the data generated from reflections of the transmitted signal detected with the spiral antenna in the compressed position to determine information associated with a moving object located beyond the second side of the wall.

26. A device comprising a spiral antenna, the device configured to:
transmit a stepped-frequency radar signal from a first side of a wall to a second side of the wall;
detect reflections of the transmitted signal with a spiral antenna in an uncompressed position;
generate data including information associated with frequency and phase shifts between the transmitted signal and the reflections of the transmitted signal detected with the spiral antenna in the uncompressed position;
analyze the data generated from reflections of the transmitted signal detected with the spiral antenna in the uncompressed position to determine information associated with a moving object located beyond the second side of the wall;
detect reflections of the transmitted signal with the spiral antenna in a compressed position;
generate data including information associated with frequency and phase shifts between the transmitted signal and the reflections of the transmitted signal detected with the spiral antenna in the compressed position; and
analyze the data generated from reflections of the transmitted signal detected with the spiral antenna in the compressed position to determine information associated with a moving object located beyond the second side of the wall.
